(19) United States
(12) Patent Application Publication
(10) Pub. No.: US 2008/0142432 A1
(43) Pub. Date: Jun. 19, 2008

(54) BAG TUBE SHAPED BODY WITH POROUS MULTILAYER STRUCTURE

(75) Inventor: Hisayoshi NONAKA, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/018,988

(22) Filed: Jan. 24, 2008

Related U.S. Application Data
(63) Continuation of application No. PCT/JP2007/055867, filed on Mar. 22, 2007.

(30) Foreign Application Priority Data
Mar. 22, 2006 (JP) 2006-079374

(51) Int. Cl. B01D 29/05

(52) U.S. Cl. 210/497.01

(57) ABSTRACT

There is disclosed a separation device of a gas or a liquid to which a separation body is installed, the separation body being constituted by using a porous multilayered structure baggy tubular body as a basal body and forming a separation membrane of the gas or the liquid on the surface of the basal body. In this separation device, the porous multilayered structure baggy tubular body includes a porous basal body having a baggy tubular shape in which one of openings of a tubular portion is closed with a baggy portion, and one or a plurality of porous layers formed on the side of one surface of the porous basal body and having an average pore diameter smaller than that of the porous basal body, so that a surface area of the separation membrane of the gas or the liquid per unit voltage is large.

### TECHNICAL FIELD

The present invention relates to a porous multilayered structure baggy tubular body having a multilayered structure of a porous material and having a baggy tubular shape.

### BACKGROUND ART

As separation means for separating and collecting a specific gas from a gas mixture to effectively use the gas, some separation methods are known in which there are used various gas or liquid separation membrane membranes, for example, a hydrogen separation membrane using a hydrogen selective transmitting metal such as palladium, a carbon membrane obtained by carbonizing an aromatic polyimide or the like, and a zeolite membrane using a zeolite having a molecule sieving function.

In many of these separation membranes, a mechanical strength of the membrane itself is low, and hence the membrane is usually formed on the surface of a cylindrical basal body having a gas or liquid transmitting property. The thus formed membrane is then disposed in a device for separation (a separation device of a gas or a liquid) as a gas or liquid separation body (the basal body+the gas or liquid separation membrane) having an improved mechanical strength.

It is to be noted that as examples of a prior document which is not directly concerned with a theme of the present invention described later but which relates to a manufacturing method of a bottomed ceramic tube having the same configuration as that of a porous multilayered structure baggy tubular body according to the present invention, and a forming method of a bottomed cylindrical member, Patent Documents 1 to 3 can be enumerated.

Patent Document 1: JP-B-7-90529;

Patent Document 2: JP-A-2004-174861;

Patent Document 3: Japanese Patent No. 3383400; and

Patent Document 4: JP-A-1-225506.

### DISCLOSURE OF THE INVENTION

However, heretofore, it has not necessarily been easy to install a gas separation body to a gas separation device in an airtight manner, that is, to install the body not so as to make a gas to be treated (a material gas) leak to a refined gas (a treated gas) side, due to the passing through a gas separation membrane. In many cases, a seal structure becomes complicated, and the number of cylindrical gas separation membranes to be installed to one gas separation device having a predetermined size has been limited to one to several membranes. Therefore, a problem has been involved that it is difficult to increase an area of the gas separation membrane per unit volume in the gas separation device.

The present invention has been developed in view of the above-mentioned conventional problem, and an object thereof is to provide a gas or liquid separation device in which a surface area of a gas or liquid separation membrane per unit volume can be increased. As a result of repeated investigations, it has been found that the above-mentioned object can be achieved by the following means.

That is, first, according to the present invention, there is provided a porous multilayered structure baggy tubular body comprising: a porous basal body having a baggy tubular shape in which one of openings of a tubular portion is closed with a baggy portion; and one or a plurality of porous layers formed on the side of one surface of the porous basal body and having an average pore diameter smaller than that of the porous basal body.

The porous basal body is a basal body having a large number pores which communicate with one surface to the other surface, and is a main constituting element of the baggy tubular body having a porous multilayered structure. In the porous multilayered structure baggy tubular body according to the present invention, since the porous basal body has a baggy tubular shape and the porous layer is formed on the surface of the basal body, the porous layer also has the baggy tubular shape. The baggy tubular shape is the shape in which one of openings of the tubular portion is closed with the baggy portion, but there is not any restriction on shapes of the tubular portion and the baggy portion. A preferable shape of the tubular portion is a cylindrical body, and a preferable shape of the baggy portion is a (hollow) semispherical shape. That is, as the whole porous multilayered structure baggy tubular body, a test-tube-like shape is an example of a preferable shape.

In the porous multilayered structure baggy tubular body according to the present invention, it is preferable that the porous basal body and the porous layer include a ceramic as a main component. In this case, it is preferable that the ceramic is one or a complex of two or more selected from the group consisting of alumina, zirconia, mullite, cordierite, silica, titania, silicon nitride and silicon carbide.

In the porous multilayered structure baggy tubular body according to the present invention, it is preferable that an average pore diameter of an outermost layer of the porous layer is 1 μm or less. When one porous layer is formed, the outermost layer is the layer. In a case where a plurality of porous layers is formed, the porous layer is a layer which is closest to a front surface side and which is most distant from the porous basal body.

In the porous multilayered structure baggy tubular body according to the present invention, it is preferable that the porous layer is constituted of a plurality of porous layers and that in order from the side of the porous basal body, a first porous layer has an average pore diameter of 5 μm or more and 20 μm or less, a second porous layer has an average pore diameter of 1 μm or more and 5 μm or less, and third and subsequent porous layers have an average pore diameter of 1 μm or less.

In the porous multilayered structure baggy tubular body according to the present invention, it is preferable that the porous layer is constituted of a plurality of layers and that in order from the side of the porous basal body, a first porous layer has an average particle diameter of 10 μm or more and 60 μm or less, a second porous layer has an average particle diameter of 2 μm or more and 15 μm or less, and third and subsequent porous layers have an average particle diameter of 2 μm or less.

In the porous multilayered structure baggy tubular body according to the present invention, it is preferable that an open pore ratio is 15% or more and 50% or less. This open pore ratio is an open pore ratio of the whole porous multilayered structure baggy tubular body including the porous basal body and the porous layer, and is measurable with a mercury porosimeter.

In the porous multilayered structure baggy tubular body according to the present invention, it is preferable that the tubular portion has a cylindrical shape, an outer diameter D of the surface of the tubular portion vertical to a central axis is φ20 mm or more, a length L in a central axis direction is 300 mm or more and the length L/the outer diameter D≧15.

In the porous multilayered structure baggy tubular body according to the present invention, it is preferable that the tubular portion and the baggy portion of the porous basal body are integrally formed by an extrusion forming process and that a difference of density is not present between the vicinity of a boundary surface between the tubular portion and the baggy portion of the porous basal body and another portion.

Next, according to the present invention, there is provided a separation body in which the porous layer of any one of the above-mentioned porous multilayered structure baggy tubular bodies is constituted as a separation membrane of a gas or a liquid.

Furthermore, according to the present invention, there is provided a separation body in which any one of the above-mentioned porous multilayered structure baggy tubular bodies is used as a base material, and a separation membrane of a gas or a liquid is formed on the surface of the base material.

In addition, according to the present invention, there is provided a separation device to which any one of the separation bodies described above is installed as separation means of a gas or a liquid.

The porous multilayered structure baggy tubular body according to the present invention has the baggy tubular shape in which one of openings of the tubular portion is closed with the baggy portion. Therefore, in a case where the body is used as the separation body, one opening on a side which is not the baggy portion may be sealed. In consequence, the body can easily be installed to the separation device of the gas or the liquid as compared with a conventional tubular separation body in which two openings are sealed.

Moreover, even in a case where it is difficult to install the separation body in an airtight manner and the seal structure becomes complicated, there is less risk of leakage as compared with the conventional tubular separation body in which two openings are sealed.

Furthermore, since a ratio occupied by the seal structure drops, it is possible to increase an area of the separation membrane of the gas or the liquid per unit volume of the separation device of the gas or the liquid. On the other hand, assuming that the area of the separation membrane of the gas or the liquid is the same, miniaturization can be achieved, and it is easy to install the device together with a catalyst device or the like.

In the porous multilayered structure baggy tubular body according to the present invention, since the tubular portion and the baggy portion of the porous basal body are integrally formed by the extrusion forming process, the baggy portion can be formed with a smooth surface having less unevenness. When the baggy portion includes a curved surface, a smooth surface can be formed.

As conventional means for forming the baggy portion, there is considered a method of forming the baggy portion by a manual operation after the tubular portion is formed with an extrusion forming machine, applying a slurry-like or paste-like ceramic to one of openings of the tubular portion and drying the ceramic to form the baggy portion, or preparing the baggy portion by use of a press forming process. However, in this method, it is difficult to form the baggy portion with the smooth surface having less unevenness. For example, in the press forming process, since a forming material has insufficient fluidity, the baggy portion cannot be formed with the smooth surface having less unevenness. It is considered that the forming material is granulated with a spray drier to secure the fluidity, and then formed. However, since particle diameters increase during the granulation, it is still difficult to form the baggy portion with the smooth surface.

In the porous multilayered structure baggy tubular body according to the present invention, since the baggy portion is formed by the extrusion forming process, a problem such as the above-mentioned conventional technology problem can be avoided. For example, even when the tubular portion has a cylindrical shape of about φ20 mm or more and φ40 mm or less and the baggy portion includes the curved surface, the baggy portion can include a smoothly formed curved surface.

### BRIEF DESCRIPTION OF THE DRAWINGS

FIG. 1 is a sectional view showing one embodiment of a porous multilayered structure baggy tubular body according to the present invention;

FIG. 2 is an enlarged sectional view showing part A of the porous multilayered structure baggy tubular body shown in FIG. 1;

FIG. 3 is a sectional view showing another embodiment of the porous multilayered structure baggy tubular body according to the present invention; and

FIG. 4 is a sectional view showing a further embodiment of the porous multilayered structure baggy tubular body according to the present invention.

### DESCRIPTION OF REFERENCE NUMERALS

10, 30 and 40: porous multilayered structure baggy tubular bodies;
11, 31 and 41: baggy portions;
12, 32 and 42: tubular portions;
13a, 13b, 33a, 33b, 43a and 43b: openings (of the tubular portions);
21: porous basal body; and
22, 23 and 24: porous layers.

### BEST MODE FOR CARRYING OUT THE INVENTION

The present invention will hereinafter appropriately be described in accordance with embodiments with reference to the drawings, but the present invention should not be limited to these embodiments when interpreted. The present invention can variously be changed, modified improved and replaced based on knowledge of any person skilled in the art without departing from the spirit of the present invention. For example, the drawings show preferable embodiments of the present invention, but the present invention is not limited by configurations shown in the drawings or information shown in the drawings. To implement or verify the present invention, means similar to that described in the present description or equivalent means is applicable, but preferable means is the following means.

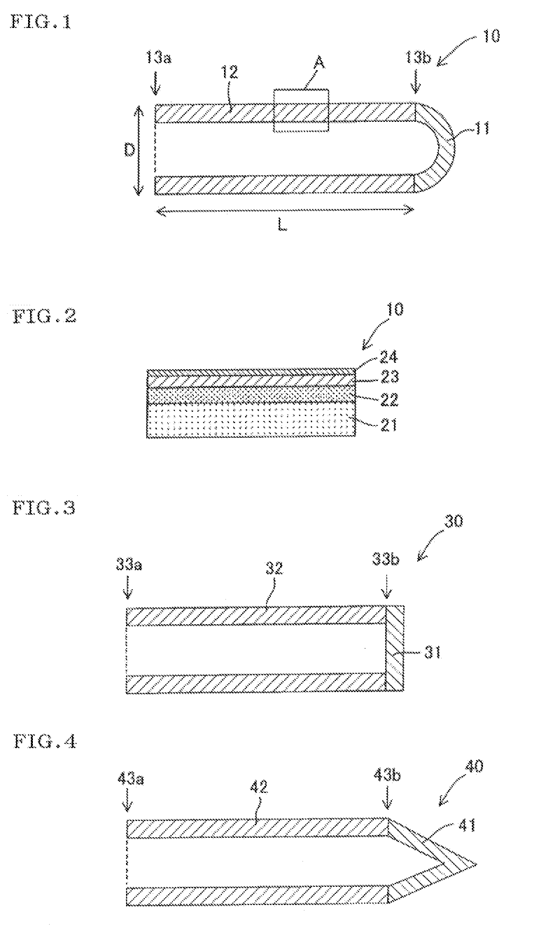

FIG. 1 is a sectional view showing one embodiment of a porous multilayered structure baggy tubular body according to the present invention. FIG. 1 shows a section parallel to an axial direction of a tubular portion. FIG. 2 is an enlarged sectional view showing part A (the tubular portion) as a part of the porous multilayered structure baggy tubular body shown in FIG. 1. A porous multilayered structure baggy tubular body 10 shown in FIGS. 1 and 2 includes a porous basal body 21 having a baggy tubular shape in which one opening 13b of two openings 13a, 13b of a tubular portion 12 is closed with a baggy portion 11, and three porous layers 22, 23 and 24 formed on the side of one surface (an outer surface which is not an inner side of the tubular portion or the baggy portion) of the porous basal body 21, and has a multilayered structure of a porous body (the porous basal body and the porous layers). The porous layers 22, 23 and 24 have an average pore diameter smaller than that of the porous basal body 21, and the average pore diameters of the porous layers 22, 23 and 24 are reduced in this order. It is to be noted that FIG. 2 shows an enlarged section of the tubular portion 12, but the porous multilayered structure baggy tubular body 10 similarly has a multilayered structure even at the baggy portion 11.

A shape of the tubular portion 12 of the porous multilayered structure baggy tubular body 10 is (for example) a cylindrical shape having an outer diameter D of φ40 mm and a length L of 600 mm, and the length L/the outer diameter D=15. A shape of the baggy portion 11 is a (hollow) semispherical shape or a shape referred to as a bowl which is a cooking utensil, and the whole porous multilayered structure baggy tubular body 10 has a test-tube-like shape.

In the porous multilayered structure baggy tubular body 10, the porous basal body 21 and the porous layers 22, 23 and 24 are formed of a material including alumina as a main component. When the porous multilayered structure baggy tubular body 10 itself is used as a base material and a separation membrane of a gas or a liquid is further formed on the surface of the material (on the porous layer 24), a separation body can be formed, and further a separation device of the gas or the liquid can be constituted. The porous basal body 21 has an average pore diameter of (for example) 20 μm. The porous layer 22 has an average pore diameter of (for example) 5 μm, the porous layer 23 has an average pore diameter of (for example) 1 μm or less, and the porous layer 24 has an average pore diameter of (for example) 0.5 μm or less. The porous multilayered structure baggy tubular body 10 has an open pore ratio of (for example) 50%.

FIG. 3 is a sectional view showing another embodiment of the porous multilayered structure baggy tubular body according to the present invention, and is a diagram showing a section of the tubular portion parallel to an axial direction. A porous multilayered structure baggy tubular body 30 shown in FIG. 3 includes a porous basal body having a baggy tubular shape in which one opening 33b of two openings 33a, 33b of a tubular portion 32 is closed with a baggy portion 31, and one porous layer (not shown) formed on the side of one surface of the porous basal body. The porous layer has an average pore diameter smaller than that of the porous basal body.

A shape of the tubular portion 32 of the porous multilayered structure baggy tubular body 30 is (for example) a cylindrical shape having an outer diameter D (the shortest distance between outer surfaces of the porous basal body passing along a central axis in a surface vertical to the central axis) of 20 mm and a length L of 400 mm, and the length L/the outer diameter D=20. A shape of the baggy portion 31 is a flat plate, and any space is not present in the baggy portion 31. The whole porous multilayered structure baggy tubular body 30 has a bottomed cylindrical body.

In the porous multilayered structure baggy tubular body 30, the porous basal body and the porous layer are formed of a material including zirconia as a main component. When the porous multilayered structure baggy tubular body 30 itself is used as a base material and a separation membrane of a gas or a liquid is further formed on the surface of the material (on the porous layer), a separation body can be formed, and further a separation device of the gas or the liquid can be constituted. The porous basal body has an average pore diameter of (for example) 50 μm. The porous layer has an average pore diameter of (for example) 10 μm or less. The porous multilayered structure baggy tubular body 30 has an open pore ratio of (for example) 15%.

FIG. 4 is a sectional view showing still another embodiment of the porous multilayered structure baggy tubular body according to the present invention, and is a diagram showing a section of the tubular portion parallel to an axial direction. A porous multilayered structure baggy tubular body 40 shown in FIG. 4 includes a porous basal body having a baggy tubular shape in which one opening 43b of two openings 43a, 43b of a tubular portion 42 is closed with a baggy portion 41, and two porous layers (not shown) formed on the side of one surface of the porous basal body. The two porous layers have an average pore diameter smaller than that of the porous basal body, and the porous layer on the side of the porous basal body has an average pore diameter larger than that of the porous layer on the upside of the layer (the side of a front surface).

A shape of the tubular portion 42 of the porous multilayered structure baggy tubular body 40 is (for example) a cylindrical shape having an outer diameter D of φ30 mm and a length L of 900 mm, and the length L/the outer diameter D=30. A shape of the baggy portion 41 is a conical shape, and the whole porous multilayered structure baggy tubular body 40 has a pen-like shape (a round pencil, ballpoint pen or the like).

In the porous multilayered structure baggy tubular body 40, the porous basal body and the two porous layers are formed of a material including cordierite as a main component. When the porous multilayered structure baggy tubular body 40 itself is used as a base material and a separation membrane of a gas or a liquid is further formed on the surface of the material (on the porous layer on the side of the front surface), a separation body can be formed, and further a separation device of the gas or the liquid can be constituted. The porous basal body has an average pore diameter of (for example) 20 μm, the porous layer on the side of the porous basal body has an average pore diameter of (for example) 5 μm, and the porous layer on the side of the front surface (the upside) is (for example) 0.8 μm or less. The porous multilayered structure baggy tubular body 40 has an open pore ratio of (for example) 20%.

### EXAMPLES

The present invention will hereinafter be described more specifically in accordance with examples.

### Example

[Forming of Porous Basal body] (1) A porous basal body was formed by an extrusion forming process. For example, 90 mass % of alumina powder having particle diameters of 10 to 100 μm and 10 mass % of glass component were used as a solid content (a main material) of the porous basal body, 10 parts by mass of aqueous binder was added to 100 parts by mass of this solid content, further 10 parts by mass of water was mixed, and these materials were introduced into a kneader and kneaded to obtain a kneaded material. Subsequently, an extrusion forming machine in which a die for forming a bag tube was installed to a clay kneader was used, and the kneaded material was introduced into this machine, and extruded to obtain a formed baggy tubular body having an outer diameter of φ30 mm, an inner diameter of φ24 mm and a length of 800 mm (for the die for forming the bag tube and the extrusion forming process, refer to Patent Document 4).

(2) Then, the resultant formed baggy tubular body was dried using a hot air drier at 100° C. overnight. Subsequently, the dried and formed baggy tubular body was heated to 500° C. with the hot air drier, the binder was removed, and the body was then fired at 1600° C. for one hour to obtain the porous basal body having the baggy tubular shape. In this case, a firing shrinkage was about 5%. An open pore ratio was 40%. As a result of measurement of pore diameters with a porosimeter, an average pore diameter was about 5 μm, and the porous basal body had a thickness of 2 mm. Unevenness of the surface generated during the firing was polished with diamond paper and flatted. It is to be noted that unlike the above-mentioned forming method, when a tubular portion is bonded to a baggy portion to form a baggy tubular shape, the portions are not smoothly bonded to each other, a difference of density is created between the vicinity of a boundary surface between the tubular portion and the baggy portion and another portion, a glass component needs to be increased in order to increase a bonding force of a bonded portion, a large amount of grass components appear at the bonded portion, and it becomes very difficult to form a porous layer later. However, according to the above-mentioned method, the unevenness is scarcely generated in the porous basal body and any density difference is not created. When a strength of the porous basal body was measured, the strength was 100 MPa. It is to be noted that the density was measured by a four-point bending strength test in conformity to JIS R 1601.

[Forming of Porous Layer] (3) The porous layer was formed by a fine particle layer suction filtering process. First, 10 mass % of alumina having an average particle diameter of 3 μm and 90 mass % of water were used as a solid content (a main material) of the porous layer, 10 parts by mass of PVA was added as a filtering resistance agent (a binder) to 100 parts by mass of this solid content, and a slurry was prepared and stored in a tank. Subsequently, the porous basal body set to a jig for exclusive use in coating was disposed in the tank containing the slurry, and submerged into the slurry, and a pressure in the porous basal body was reduced to −0.06 MPa by use of a vacuum pump. After this state was retained for two minutes (referred to as a coating time), the porous basal body uniformly coated with the slurry forming the porous layer was pulled up from the tank. Then, after the basal body was dried overnight, the basal body was fired at 1500° C. for one hour (referred to as firing conditions). The resultant first porous layer had a thickness of 100 μm.

(4) A second porous layer was further formed on the porous basal body provided with the first porous layer by the same method as that of the above step (3) except that alumina having an average particle diameter of 1 μm was used, a coating time was set to one minute and firing conditions were set to 1400° C. and one hour. The resultant second porous layer had a thickness of 50 μm.

(5) A third porous layer was further formed on the porous basal body provided with the first and second porous layers by the same method as that of the above step (3) except that alumina having an average particle diameter of 0.5 μm was used, a coating time was set to one minute and firing conditions were set to 1400° C. and one hour, and a porous multilayered structure baggy tubular body was obtained. The resultant third porous layer had a thickness of 50 μm.

When a porosity of the whole resultant porous multilayered structure baggy tubular body was measured with a mercury porosimeter, the porosity was 30%. When a helium gas was circulated outside the porous multilayered structure baggy tubular body on conditions of room temperature and a pressure of 0.2 MPa and a pressure loss was measured and evaluated, the loss was 1.14 kgf/(1/min). After the baggy portion of this sample was cut and a flange was installed to measure the loss (O-ring specifications) the loss was 1.05 kgf/(1/min). The baggy tubular shape did not have any leak in seal, and satisfactorily tended to have a large pressure difference.

### INDUSTRIAL APPLICABILITY

A porous multilayered structure baggy tubular body according to the present invention is separation means for separating a specific gas from a gas mixture. The basal body can be used as a basal body of a separation body which supports a gas or liquid separation membrane such as a zeolite membrane, or as a separation body itself having a separation performance.

1. A porous multilayered structure baggy tubular body comprising:
a porous basal body having a baggy tubular shape in which one of openings of a tubular portion is closed with a baggy portion; and
one or a plurality of porous layers formed on the side of one surface of the porous basal body and having an average pore diameter smaller than that of the porous basal body.

2. The porous multilayered structure baggy tubular body according to claim 1, wherein the porous basal body and the porous layer include a ceramic as a main component.

3. The porous multilayered structure baggy tubular body according to claim 2, wherein the ceramic is one or a complex of two or more selected from the group consisting of alumina, zirconia, mullite, cordierite, silica, titania, silicon nitride and silicon carbide.

4. The porous multilayered structure baggy tubular body according to claim 1, wherein an average pore diameter of an outermost layer of the porous layer is 1 μm or less.

5. The porous multilayered structure baggy tubular body according to claim 1, wherein the porous layer is constituted of a plurality of layers, and in order from the side of the porous basal body, a first porous layer has an average pore diameter of 5 μm or more and 20 μm or less, a second porous layer has an average pore diameter of 1 μm or more and 5 μm or less, and third and subsequent porous layers have an average pore diameter of 1 μm or less.

6. The porous multilayered structure baggy tubular body according to claim 1, wherein the porous layer is constituted of a plurality of layers, and in order from the side of the porous basal body, a first porous layer has an average particle diameter of 10 μm or more and 60 μm or less, a second porous layer has an average particle diameter of 2 μm or more and 15 μm or less, and third and subsequent porous layers have an average particle diameter of 2 μm or less.

7. The porous multilayered structure baggy tubular body according to claim 1, wherein the porous multilayered structure baggy tubular body has an open pore ratio of from 15% or more to 50% or less.

8. The porous multilayered structure baggy tubular body according to claim 1, wherein the tubular portion has a cylindrical shape, an outer diameter D of the surface of the tubular portion vertical to a central axis is φ20 mm or more, a length L in a central axis direction is 300 mm or more, and the length L/the outer diameter D≧15.

9. The porous multilayered structure baggy tubular body according to claim 1, wherein the tubular portion and the baggy portion of the porous basal body are integrally formed by an extrusion forming process, and a difference of density is not present between the vicinity of a boundary surface between the tubular portion and the baggy portion of the porous basal body and another portion.

10. A separation body, wherein a separation membrane of a gas or a liquid of the separation body is constituted by a porous multilayered structure baggy tubular body comprising a porous basal body having a baggy tubular shape in which one of openings of a tubular portion is closed with a baggy portion; and one or a plurality of porous layers formed on the side of one surface of the porous basal body and having an average pore diameter smaller than that of the porous basal body.

11. A separation body according to claim 10, wherein a separation membrane of a gas or a liquid is formed on a surface of the porous multilayered structure baggy tubular body.

12. A separation device being installed with a separation body, as separation means of a gas or a liquid, wherein a separation membrane of a gas or a liquid of the separation body is constituted by a porous multilayered structure baggy tubular body comprising a porous basal body having a baggy tubular shape in which one of openings of a tubular portion is closed with a baggy portion; and one or a plurality of porous layers formed on the side of one surface of the porous basal body and having an average pore diameter smaller than that of the porous basal body.
